(19) United States
(12) Patent Application Publication
(10) Pub. No.: US 2024/0331910 A1
(43) Pub. Date: Oct. 3, 2024

(54) ELECTRONIC COMPONENT

(71) Applicant: TDK CORPORATION, Tokyo (JP)

(72) Inventors: Keito YASUDA, Tokyo (JP); Yusuke Nagai, Tokyo (JP); Makoto Yoshino, Tokyo (JP); Shinichi Sato, Tokyo (JP); Yuya Ishima, Tokyo (JP); Youhei IIDA, Tokyo (JP); Mitsuharu Koike, Tokyo (JP); Takato Sasaki, Tokyo (JP)

(73) Assignee: TDK CORPORATION, Tokyo (JP)

(21) Appl. No.: 18/404,044

(22) Filed: Jan. 4, 2024

(30) Foreign Application Priority Data
Mar. 30, 2023 (JP) 2023-055444

(51) Int. Cl. H01F 17/00; H01F 27/25

(52) U.S. Cl. CPC H01F 17/0013; H01F 27/25

(57) ABSTRACT

A coil component includes an element body having a mounting surface, and a terminal electrode disposed on the mounting surface, in which at least a part of the terminal electrode is embedded in the element body, the terminal electrode has an opening penetrating the terminal electrode in a direction orthogonal to the mounting surface, and a part of the element body is disposed in the opening.

### TECHNICAL FIELD

The present disclosure relates to an electronic component.

### BACKGROUND

Patent Literature 1 (Japanese Unexamined Patent Publication No. 2018-56197) discloses an electronic component including an element body having a mounting surface, a coil disposed in the element body, and an external conductor disposed on the mounting surface of the element body and connected to the coil.

### SUMMARY

An object of one aspect of the present disclosure is to provide an electronic component capable of suppressing peeling of an external conductor from an element body.
(1) An electronic component according to one aspect of the present disclosure includes: an element body having a mounting surface; and an external conductor disposed on the mounting surface, in which at least a part of the external conductor is embedded in the element body, the external conductor has an opening penetrating the external conductor in a direction orthogonal to the mounting surface, and a part of the element body is disposed in the opening.

In the electronic component according to one aspect of the present disclosure, the external conductor has an opening penetrating the external conductor in a direction orthogonal to the mounting surface. In this configuration, in the electronic component, a part of the element body is disposed in the opening. As described above, in the electronic component, since a part of the element body enters the opening of the external conductor, the adhesion between the external conductor and the element body can be enhanced by an anchor effect. Therefore, in the electronic component, it is possible to suppress peeling of the external conductor from the element body.
(2) In the electronic component according to (1), the element body may include a plurality of metal magnetic particles of a soft magnetic material, and the metal magnetic particles may be disposed in the opening of the external conductor. In this configuration, since the metal magnetic particles enter the opening of the external conductor, the adhesion between the external conductor and the element body can be enhanced by an anchor effect.
(3) In the electronic component according to (1) or (2), a conductive member having conductivity may be filled in the opening of the external conductor on the element body. In this configuration, since the opening is filled with the conductive member, an increase in direct current resistance (Rdc) of the external conductor can be suppressed even when the opening is formed in the external conductor.
(4) In electronic component according to any one of (1) to (3), the external conductor may be a plated conductor. When the external conductor is a sintered metal conductor, the external conductor is formed by sintering a metal component (metal powder) contained in the conductive paste. When the metal magnetic particles are included in the element body, the metal magnetic particles bite into the conductive paste in a process before the metal component is sintered, and irregularities resulting from the shape of the metal magnetic particles are formed on the surface of the conductive paste. The formed external conductor is deformed such that the metal magnetic particles bite into the external conductor. Therefore, the configuration in which the external conductor is a sintered metal conductor significantly increases the surface roughness of the external conductor. On the other hand, when the external conductor is a plated conductor, the metal magnetic particles hardly bite into the external conductor, and deformation of the external conductor is suppressed. Therefore, the configuration in which the external conductor is a plated conductor suppresses an increase in surface roughness of the external conductor and suppresses an increase in surface resistance.
(5) In the electronic component according to any one of (1) to (4), the external conductor may have a lattice shape. In this configuration, the external conductor has a plurality of openings. Therefore, in the electronic component, since an anchor effect can be further obtained, the adhesion between the external conductor and the element body can be further enhanced. Therefore, in the electronic component, it is possible to further suppress peeling of the external conductor from the element body.
(6) The electronic component according to any one of (1) to (5) may further include a plating layer disposed on the external conductor and disposed to straddle the opening. In this configuration, since the opening is covered with the plating layer, an increase in direct current resistance (Rdc) of the external conductor can be suppressed even when the opening is formed in the external conductor.

According to one aspect of the present disclosure, it is possible to suppress peeling of the external conductor from the element body.

### BRIEF DESCRIPTION OF THE DRAWINGS

FIG. 1 is a perspective view illustrating a coil component according to an embodiment;

FIG. 2 is a transparent perspective view of the coil component illustrated in FIG. 1;

FIG. 3 is an exploded perspective view of the coil component;

FIG. 4 is a view of the coil component as viewed from a mounting surface side;

FIG. 5A is a view illustrating a cross-sectional configuration of the coil component, and FIG. 5B is a schematic enlarged view illustrating a cross-sectional configuration of a part of FIG. 5A;

FIG. 6A is a view illustrating a cross-sectional configuration of a coil component according to another embodiment, and FIG. 6B is a schematic enlarged view illustrating a cross-sectional configuration of a part of FIG. 6A;

FIG. 7A is a view illustrating a cross-sectional configuration of a coil component according to another embodiment, and FIG. 7B is a schematic enlarged view illustrating a cross-sectional configuration of a part of FIG. 7A;

FIGS. 8A, 8B, 8C, and 8D are views of a coil component according to another embodiment as viewed from a mounting surface side;

FIGS. 9A, 9B, 9C, and 9D are views of a coil component according to another embodiment as viewed from a mounting surface side;

FIGS. 10A, 10B, 10C, and 10D are views of a coil component according to another embodiment as viewed from a mounting surface side; and

FIGS. 11A, 11B, and 11C are views of a coil component according to another embodiment as viewed from a mounting surface side.

### DETAILED DESCRIPTION

Hereinafter, preferred embodiments of the present invention will be described in detail with reference to the accompanying drawings. Note that the same or corresponding elements in the description of the drawings are denoted by the same reference signs, and redundant description is omitted.

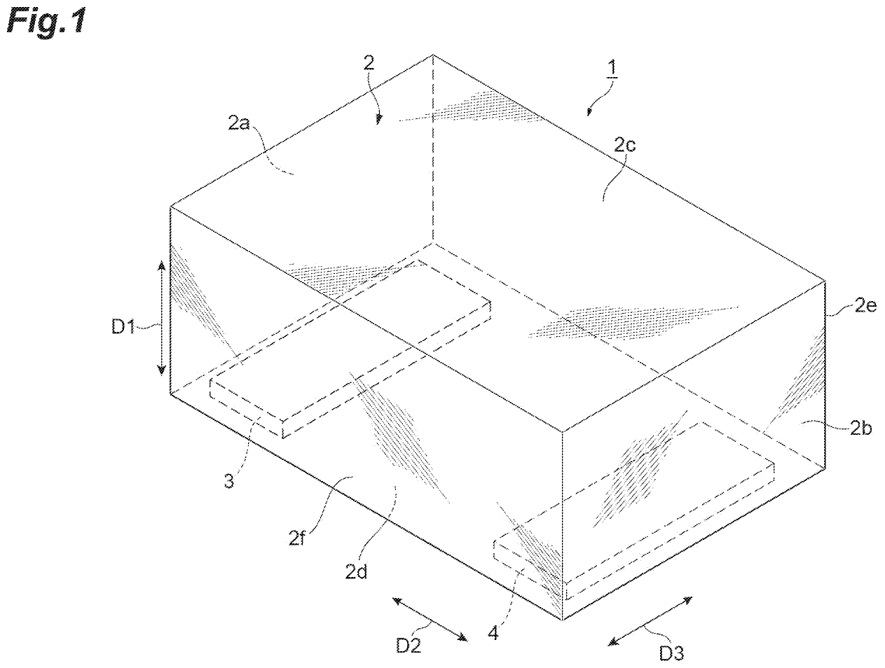

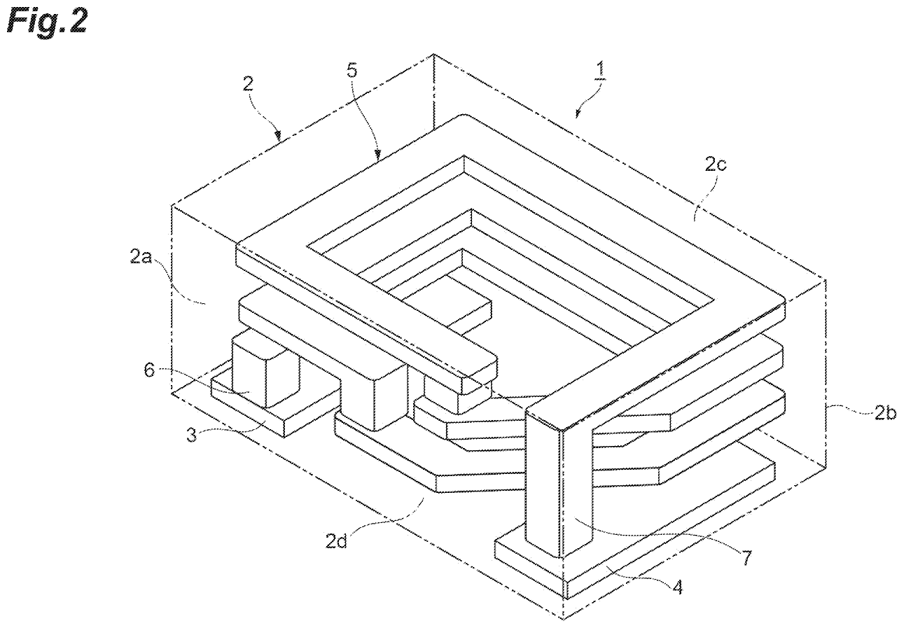

A coil component will be described with reference to FIGS. 1 and 2. FIG. 1 is a perspective view illustrating a coil component according to an embodiment. FIG. 2 is a transparent perspective view of the coil component illustrated in FIG. 1. As illustrated in FIGS. 1 and 2, a coil component (electronic component) 1 includes an element body 2, terminal electrodes (external conductors) 3 and 4, a coil 5, and first and second connection conductors 6 and 7. In FIG. 2, the element body 2 is indicated by a broken line for convenience of description.

The element body 2 has a rectangular parallelepiped shape. The rectangular parallelepiped shape includes a rectangular parallelepiped shape in which corner portions and ridge line portions are chamfered, or a rectangular parallelepiped shape in which corner portions and ridge line portions are rounded. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, an opposing direction of the main surfaces 2c and 2d is referred to as a first direction D1, an opposing direction of the end surfaces 2a and 2b is referred to as a second direction D2, and an opposing direction of the side surfaces 2e and 2f is referred to as a third direction D3. The first direction D1, the second direction D2, and the third direction D3 are substantially orthogonal to each other.

The end surfaces 2a and 2b extend in the first direction D1 so as to connect the main surfaces 2c and 2d. The end surfaces 2a and 2b also extend in the third direction D3 so as to connect the side surfaces 2e and 2f. The main surfaces 2c and 2d extend in the second direction D2 so as to connect the end surfaces 2a and 2b. The main surfaces 2c and 2d also extend in the third direction D3 so as to connect the side surfaces 2e and 2f. The side surfaces 2e and 2f extend in the first direction D1 so as to connect the main surfaces 2c and 2d. The side surfaces 2e and 2f also extend in the second direction D2 so as to connect the end surfaces 2a and 2b.

The main surface 2d is a mounting surface, and is, for example, a surface facing another electronic device (for example, a circuit substrate or a laminated electronic component) (not illustrated) when the coil component 1 is mounted on the another electronic device. The end surfaces 2a and 2b are surfaces continuous from the mounting surface (that is, the main surface 2d).

The length of the element body 2 in the second direction D2 is longer than the length of the element body 2 in the first direction D1 and the length of the element body 2 in the third direction D3. The length of the element body 2 in the third direction D3 is longer than the length of the element body 2 in the first direction D1. That is, in the present embodiment, the end surfaces 2a and 2b, the main surfaces 2c and 2d, and the side surfaces 2e and 2f have a rectangular shape. The length of the element body 2 in the first direction D1 may be equivalent to the length of the element body 2 in the third direction D3, or many be shorter than the length thereof.

It should be noted that “equivalent” in the present embodiment may mean not only “equal” but also a value including a slight difference, a manufacturing error, or the like in a preset range. For example, it is defined that a plurality of values are equivalent insofar as the plurality of values are included in the range of 95% to 105% of the average value of the plurality of values.

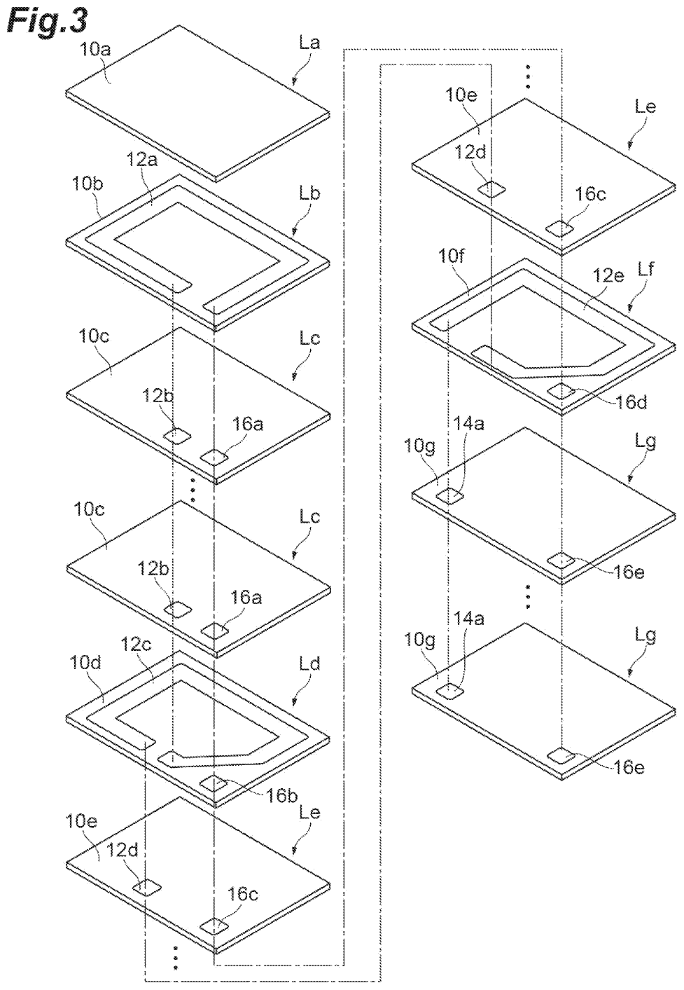

The element body 2 is formed by laminating a plurality of element body layers (insulator layers) 10a to 10g (see FIG. 3) in the first direction D1. That is, the lamination direction of the element body 2 is the first direction D1. A specific laminated configuration will be described below. In the actual element body 2, the plurality of element body layers 10a to 10g are integrated to such an extent that boundaries between the element body layers cannot be visually recognized.

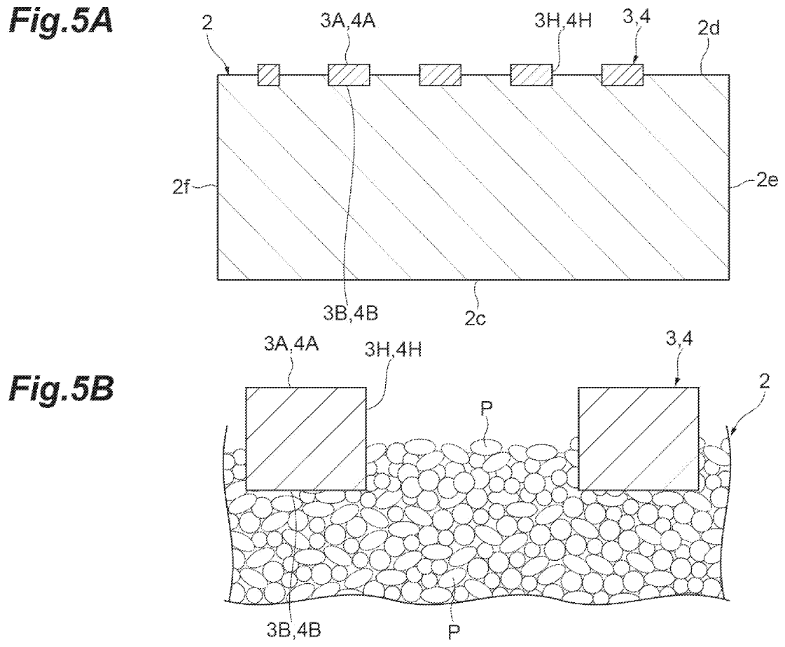

The element body layers 10a to 10g include a plurality of metal magnetic particles P (see FIG. 5B). The metal magnetic particles P are made of a soft magnetic alloy (soft magnetic material). The soft magnetic alloy is, for example, a Fe—Si-based alloy. When the soft magnetic alloy is a Fe—Si-based alloy, the soft magnetic alloy may contain P. The soft magnetic alloy may be, for example, a Fe—Ni—Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements.

In the element body 2, the metal magnetic particles P and P are bonded to each other. The bonding between the metal magnetic particles P and P is realized by, for example, bonding between oxide films (not illustrated) formed on the surfaces of the metal magnetic particles P. The thickness of the oxide film is, for example, 5 nm or more and 60 nm or less. The oxide film may be configured by one or a plurality of layers.

Each of the terminal electrode 3 and the terminal electrode 4 is provided in the element body 2. Each of the terminal electrode 3 and the terminal electrode 4 is disposed on the main surface 2d of the element body 2. The terminal electrode 3 and the terminal electrode 4 are provided in the element body 2 so as to be separated from each other in the second direction D2. Specifically, the terminal electrode 3 is disposed on the end surface 2a side of the element body 2. The terminal electrode 4 is disposed on the end surface 2b side of the element body 2.

Each of the terminal electrode 3 and the terminal electrode 4 is made of, for example, a conductive material such as Cu, Ni, Sn, or Au. In the present embodiment, each of the terminal electrode 3 and the terminal electrode 4 is a plated electrode (plated conductor) formed by plating (electrolytic plating or electroless plating). Each of the terminal electrode 3 and the terminal electrode 4 may have a single-layer structure or a multi-layer structure.

The coil 5 is disposed in the element body 2. The coil 5 is configured by a plurality of coil conductor layers 12a to 12e (see FIG. 3). The plurality of coil conductor layers 12a to 12e are electrically connected to each other and constitute the coil 5 in the element body 2. The coil axis of the coil 5 is provided along the first direction D1. The coil conductor layers 12a to 12e are disposed in such a way as to at least partially overlap each other as viewed from the first direction D1. The plurality of coil conductor layers 12b to 12e are made of a conductive material (for example, Ag or Pd). In the present embodiment, the plurality of coil conductor layers 12a to 12e are plated conductors. The coil conductor layers 12a to 12e are disposed apart from the end surfaces 2a and 2b, the main surfaces 2c and 2d, and the side surfaces 2e and 2f.

The first connection conductor 6 is disposed in the element body 2. The first connection conductor 6 connects the terminal electrode 3 and the coil 5. The first connection conductor 6 is a through-hole conductor. The first connection conductor 6 extends in the first direction D1 and is connected to the terminal electrode 3 and one end of the coil 5. The first connection conductor 6 is configured by a plurality of first connection conductor layers 14a (see FIG. 3). In the present embodiment, the first connection conductor 6 has a rectangular cross section (cross section along the second direction D2 and the third direction D3) orthogonal to the extension direction (first direction D1). That is, the first connection conductor 6 has a prismatic shape.

The second connection conductor 7 is disposed in the element body 2. The second connection conductor 7 connects the terminal electrode 4 and the coil 5. The second connection conductor 7 is a through-hole conductor. The second connection conductor 7 extends in the first direction D1 and is connected to the terminal electrode 4 and the other end of the coil 5. The second connection conductor 7 is configured by a plurality of second connection conductor layers 16a, 16b, 16c, 16d, and 16e (see FIG. 3). In the present embodiment, the second connection conductor 7 has a rectangular cross section (cross section along the second direction D2 and the third direction D3) orthogonal to the extension direction (first direction D1). That is, the second connection conductor 7 has a prismatic shape.

FIG. 3 is an exploded perspective view of the coil component illustrated in FIG. 1. As illustrated in FIG. 3, the coil component 1 includes a plurality of layers La, Lb, Lc, Ld, Le, Lf, and Lg. The coil component 1 is configured by, for example, laminating the layers La to Lg in order from the main surface 2c side. The coil component 1 according to the present embodiment includes a plurality of layers Lc and a plurality of layers Lg.

The layer La is configured by the element body layer 10a. The layer La constitutes the main surface 2c of the element body 2.

The layer Lb is configured by mutually combining the element body layer 10b and the coil conductor layer 12a. The element body layer 10b is provided with a defective portion (not illustrated) which has a shape corresponding to the coil conductor layer 12a and into which the coil conductor layer 12a is fitted. The element body layer 10b and the coil conductor layer 12a have a mutually complementary relationship.

The layer Lc is configured by mutually combining the element body layer 10c, the coil conductor layer 12b, and the second connection conductor layer 16a. The element body layer 10c is provided with a defective portion (not illustrated) which has a shape corresponding to the coil conductor layer 12b and the second connection conductor layer 16a and into which the coil conductor layer 12b and the second connection conductor layer 16a are fitted. The element body layer 10c and the entirety of the coil conductor layer 12b and the second connection conductor layer 16a have a mutually complementary relationship.

The layer Ld is configured by mutually combining the element body layer 10d, the coil conductor layer 12c, and the second connection conductor layer 16b. The element body layer 10d is provided with a defective portion (not illustrated) which has a shape corresponding to the coil conductor layer 12c and the second connection conductor layer 16b and into which the coil conductor layer 12c and the second connection conductor layer 16b are fitted. The element body layer 10d and the entirety of the coil conductor layer 12c and the second connection conductor layer 16b have a mutually complementary relationship.

The layer Le is configured by mutually combining the element body layer 10e, the coil conductor layer 12d, and the second connection conductor layer 16c. The element body layer 10e is provided with a defective portion (not illustrated) which has a shape corresponding to the coil conductor layer 12d and the second connection conductor layer 16c and into which the coil conductor layer 12d and the second connection conductor layer 16c are fitted. The element body layer 10e and the entirety of the coil conductor layer 12d and the second connection conductor layer 16c have a mutually complementary relationship.

The layer Lf is configured by mutually combining the element body layer 10f, the coil conductor layer 12e, and the second connection conductor layer 16d. The element body layer 10f is provided with a defective portion (not illustrated) which has a shape corresponding to the coil conductor layer 12e and the second connection conductor layer 16d and into which the coil conductor layer 12e and the second connection conductor layer 16d are fitted. The element body layer 10f and the entirety of the coil conductor layer 12e and the second connection conductor layer 16d have a mutually complementary relationship.

The layer Lg is configured by mutually combining the element body layer 10g, the first connection conductor layer 14a, and the second connection conductor layer 16e. The element body layer 10g is provided with a defective portion (not illustrated) which has a shape corresponding to the first connection conductor layer 14a and the second connection conductor layer 16e and into which the first connection conductor layer 14a and the second connection conductor layer 16e are fitted. The element body layer 10g and the entirety of the first connection conductor layer 14a and the second connection conductor layer 16e have a mutually complementary relationship. The layer Lg constitutes the main surface 2d of the element body 2.

Subsequently, the terminal electrode 3 and the terminal electrode 4 will be described in detail.

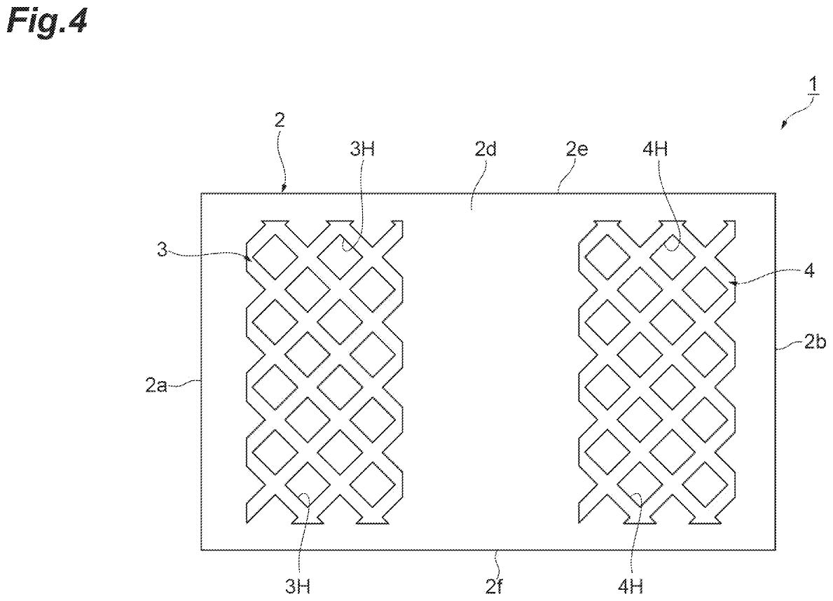

FIG. 4 is a view of the coil component 1 as viewed from the mounting surface (main surface 2d). As illustrated in FIG. 4, the terminal electrode 3, 4 has a lattice shape (mesh shape). The terminal electrode 3, 4 has a plurality of openings 3H, 4H. In the present embodiment, the opening 3H, 4H has a rectangular shape as viewed from the first direction D1. The opening 3H, 4H is formed to penetrate the terminal electrode 3, 4 in the first direction D1 (direction orthogonal to the main surface 2d, thickness direction). The opening 3H, 4H is formed to penetrate a first surface 3A, 4A (see FIG. 5A) and a second surface 3B, 4B (see FIG. 5A) of the terminal electrode 3, 4.

FIG. 5A is a view illustrating a cross-sectional configuration of the coil component 1, and FIG. 5B is a schematic enlarged view illustrating a cross-sectional configuration of a part of FIG. 5A. In FIG. 5A, the coil 5 is not illustrated.

As illustrated in FIGS. 5A and 5B, a part of the terminal electrode 3, 4 is embedded in the element body 2. Specifically, a part of the terminal electrode 3, 4 on the main surface 2c side is embedded in the element body 2. The second surface 3B, 4B of the terminal electrode 3, 4 is located closer to the main surface 2c side than the main surface 2d. A part of the element body 2 is disposed in the opening 3H, 4H of the terminal electrode 3, 4. That is, the element body 2 exists in the space formed by the openings 3H, 4H. In the present embodiment, as viewed from the first direction D1, the element body 2 is exposed at the opening 3H, 4H of the terminal electrode 3, 4. In the examples of FIGS. 5A and 5B, in the opening 3H, 4H, an upper portion (surface exposed at the opening 3H, 4H) of the element body 2 is located closer to the main surface 2c side than the first surface 3A, 4A of the terminal electrode 3, 4.

As illustrated in FIG. 5B, the plurality of metal magnetic particles P are disposed (filled) in the opening 3H, 4H of the terminal electrode 3, 4. The average particle size of the metal magnetic particles P disposed in the opening 3H, 4H may be smaller than the average particle size of the metal magnetic particles P (metal magnetic particles P not disposed in the opening 3H, 4H) of the element body 2.

The average particle size is obtained, for example, as follows. A cross-sectional photograph of the coil component 1 is acquired. The cross-sectional photograph is obtained, for example, by photographing a cross section when the coil component 1 is cut along a plane parallel to the pair of end surfaces 2a and 2b and separated from the pair of end surfaces 2a and 2b by a predetermined distance. In this case, the plane may be located at an equal distance from the pair of end surfaces 2a and 2b. The acquired cross-sectional photograph is subjected to image processing by software. The boundary of the metal magnetic particles P is determined by image processing, and the area of the metal magnetic particles P is obtained. From the obtained area of the metal magnetic particles P, a particle size converted into an equivalent circle diameter is obtained. Here, the particle sizes of 100 or more metal magnetic particles P are calculated, and the particle size distribution of these metal magnetic particles P is obtained. The particle size (d50) at an integrated value of 50% in the obtained particle size distribution is taken as “average particle size”. The particle shape of the metal magnetic particles P is not particularly limited.

As described above, in the coil component 1 according to the present embodiment, the terminal electrode 3, 4 has an opening 3H, 4H penetrating the terminal electrode 3, 4 in a direction orthogonal to the main surface 2d. In this configuration, in the coil component 1, a part of the element body 2 is disposed in the opening 3H, 4H. As described above, in the coil component 1, since a part of the element body 2 enters the opening 3H, 4H of the terminal electrode 3, 4, the adhesion between the terminal electrode 3, 4 and the element body 2 can be enhanced by an anchor effect. Therefore, in the coil component 1, it is possible to suppress peeling of the terminal electrode 3, 4 from the element body 2.

In the coil component 1, in the case of a configuration in which the terminal electrode 3, 4 does not have the opening 3H, 4H (in the case of the configuration disclosed in Patent Literature 1), since the contact area between the element body 2 and the terminal electrode 3, 4 is small, the terminal electrode 3, 4 may be separated from the element body 2 when stress (external force) is applied to the terminal electrode 3, 4. In the coil component 1 according to the present embodiment, since the adhesion between the terminal electrode 3, 4 and the element body 2 can be enhanced, it is possible to suppress peeling of the terminal electrode 3, 4 from the element body 2.

In the coil component 1 according to the present embodiment, the element body 2 includes a plurality of metal magnetic particles P of a soft magnetic material. In the coil component 1, the metal magnetic particles P are disposed in the opening 3H, 4H of the terminal electrode 3, 4. In this configuration, since the metal magnetic particles P enter the opening 3H, 4H of the terminal electrode 3, 4, the adhesion between the terminal electrode 3, 4 and the element body 2 can be enhanced by an anchor effect.

In the coil component 1 according to the present embodiment, the terminal electrode 3, 4 is a plated electrode. When the terminal electrode 3, 4 is a sintered metal conductor, the terminal electrode 3, 4 is formed by sintering a metal component (metal powder) contained in the conductive paste. When the metal magnetic particles P are included in the element body 2, the metal magnetic particles P bite into the conductive paste in a process before the metal component is sintered, and irregularities resulting from the shape of the metal magnetic particles P are formed on the surface of the conductive paste. The formed terminal electrode 3, 4 is deformed such that the metal magnetic particles P bite into the terminal electrode 3, 4. Therefore, the configuration in which the terminal electrode 3, 4 is a sintered metal conductor significantly increases the surface roughness of the terminal electrode 3, 4. On the other hand, when the terminal electrode 3, 4 is a plated electrode, the metal magnetic particles P hardly bite into the terminal electrode 3, 4, and deformation of the terminal electrode 3, 4 is suppressed. Therefore, the configuration in which the terminal electrode 3, 4 is a plated electrode suppresses an increase in surface roughness of the terminal electrode 3, 4 and suppresses an increase in surface resistance.

In the coil component 1 according to the present embodiment, the terminal electrode 3, 4 has a lattice shape. In this configuration, the terminal electrode 3, 4 has a plurality of openings 3H, 4H. Therefore, in the coil component 1, since an anchor effect can be further obtained, the adhesion between the terminal electrode 3, 4 and the element body 2 can be further enhanced. Therefore, in the coil component 1, it is possible to further suppress peeling of the terminal electrode 3, 4 from the element body 2.

Although the embodiments of the present disclosure have been described above, the present disclosure is not necessarily limited to the above-described embodiments, and various modifications can be made without departing from the gist thereof.

In the above embodiment, the coil component 1 has been described as an example of the electronic component. However, the electronic component is not limited to the coil component, and may be another electronic component.

In the above embodiment, a mode in which the coil 5 includes the plurality of coil conductor layers 12a to 12e has been described as an example. However, the number and shape of the coil conductors constituting the coil are not limited.

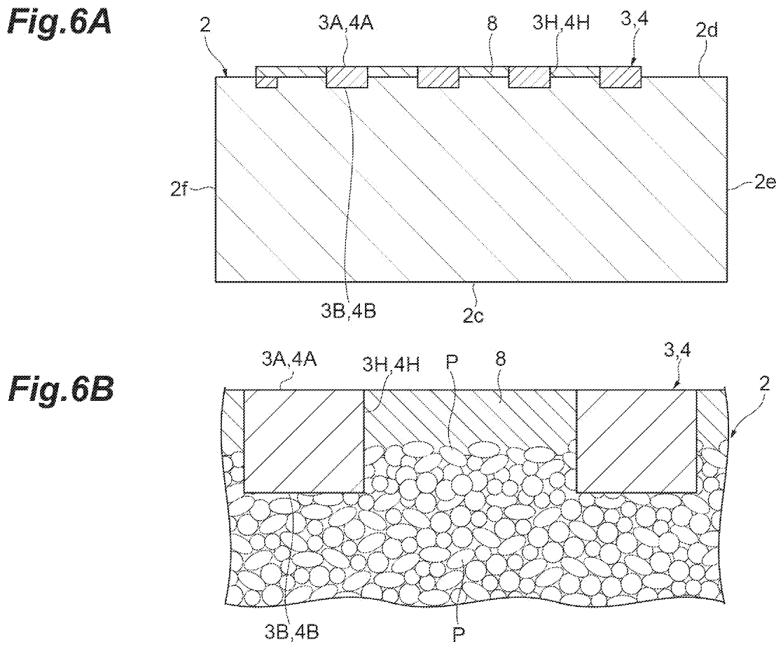

In addition to the above embodiment, as illustrated in FIGS. 6A and 6B, the opening 3H, 4H of the terminal electrode 3, 4 may be filled with a conductive member 8. The conductive member 8 is a member having conductivity, and is made of a conductive material (for example, Ag or Cu). The surface of the conductive member 8 may be flush with the first surface 3A, 4A of the opening 3H, 4H, or may be located closer to the main surface 2c side than the first surface 3A, 4A. The conductive member 8 covers the surface of the element body 2 (metal magnetic particles P) in the opening 3H, 4H. In this configuration, since the opening 3H, 4H is filled with the conductive member 8, an increase in direct current resistance (Rdc) of the terminal electrode 3, 4 can be suppressed even when the opening 3H, 4H is formed in the terminal electrode 3, 4.

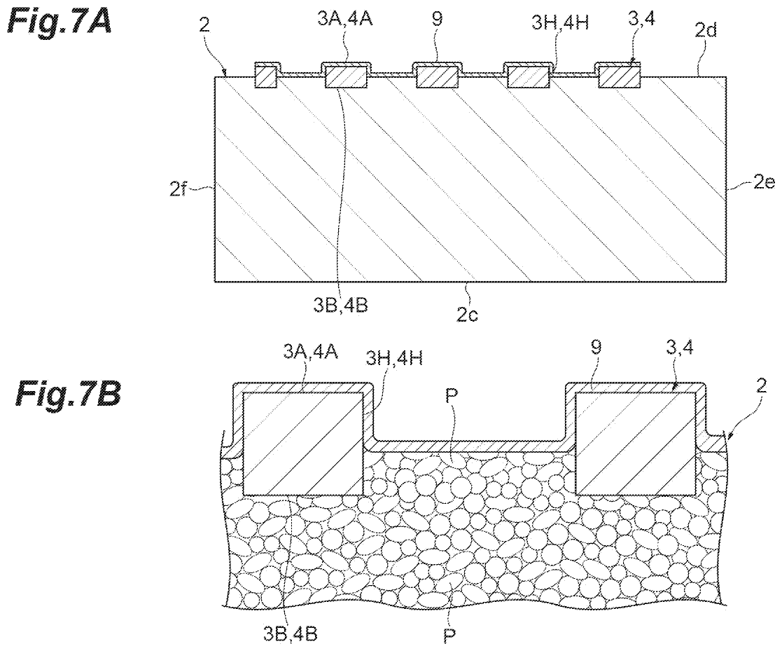

In addition to the above embodiment, as illustrated in FIGS. 7A and 7B, a plating layer 9 may be disposed on the terminal electrode 3, 4. The plating layer 9 is disposed to straddle the opening 3H, 4H. The plating layer 9 is formed by performing electrolytic plating or electroless plating. The plating layer 9 contains, for example, Ni, Sn, Au, or the like. The plating layer may have a single-layer structure or a multi-layer structure. The plating layer 9 is disposed on the element body 2 in the opening 3H, 4H (covers the element body 2). In this configuration, since the opening 3H, 4H is covered with the plating layer 9, an increase in direct current resistance (Rdc) of the terminal electrode 3, 4 can be suppressed even when the opening 3H, 4H is formed in the terminal electrode 3, 4.

In the examples of FIGS. 7A and 7B, in the opening 3H, 4H, the plating layer 9 is disposed on the element body 2, but a conductive member may be disposed between the plating layer 9 and the element body 2.

In the above embodiment, a mode in which the opening 3H, 4H of the terminal electrode 3, 4 has a rectangular shape has been described as an example. However, the shape of the opening 3H, 4H is not limited thereto. The opening 3H, 4H is a portion forming an opening region (space), and may form a closed region or may not form a closed region. That is, in the opening 3H, 4H, the side surfaces forming the openings may be continuous or may not be continuous (may be intermittent). The opening 3H, 4H preferably has a shape in which the terminal electrode 3, 4 is caught by the element body 2 in the opening 3H, 4H when a force is applied to the terminal electrode 3, 4 in the second direction D2 and/or the third direction D3. That is, the shape of the opening 3H, 4H is preferably such a shape that the movement (deviation) of the terminal electrode 3, 4 is restricted by the element body 2 in the opening 3H, 4H.

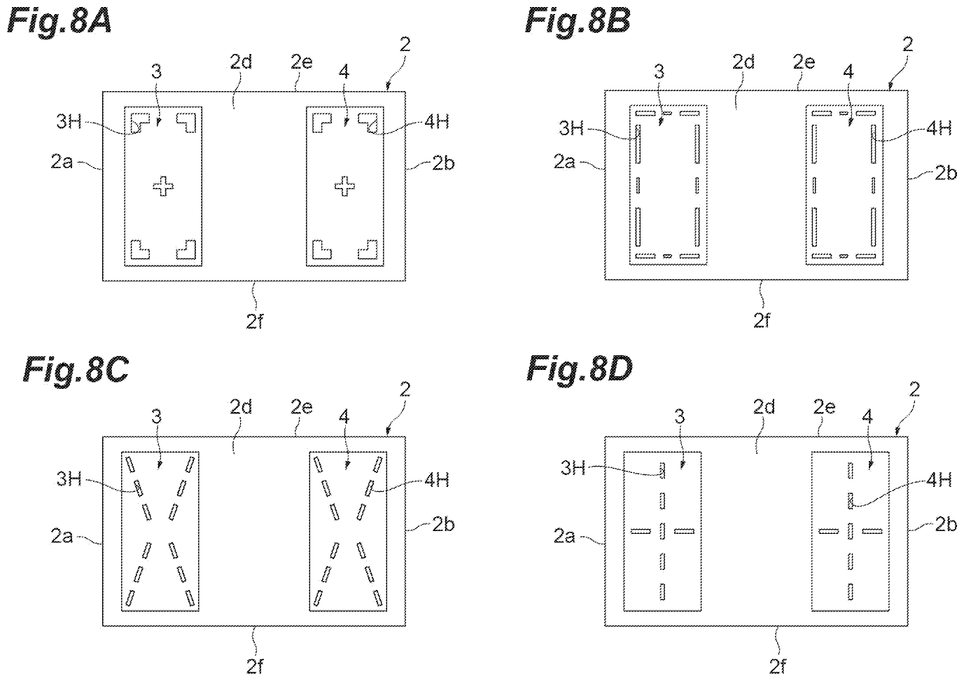

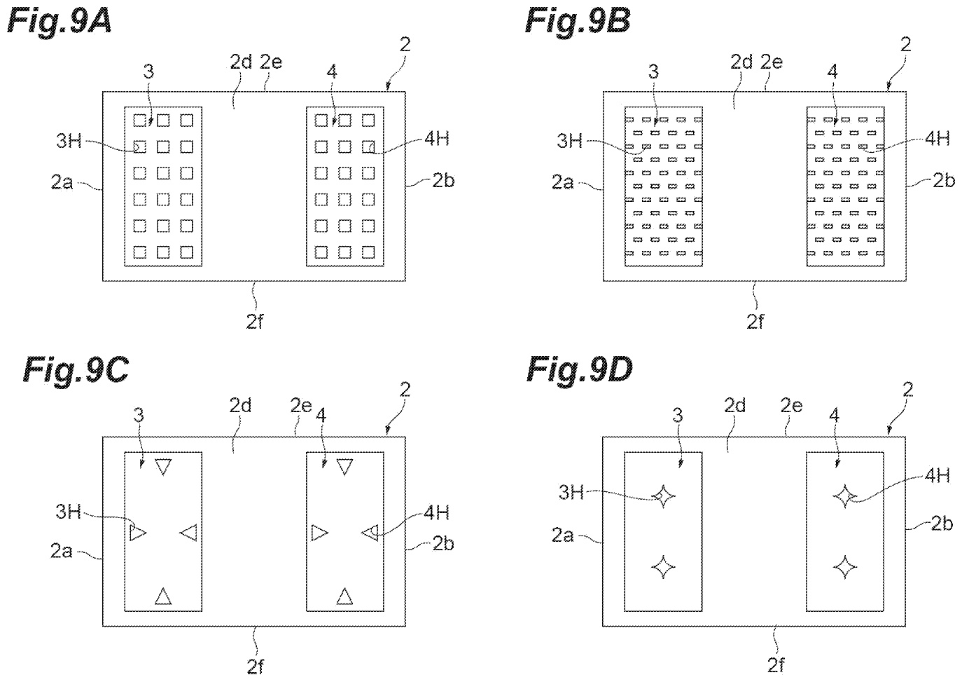

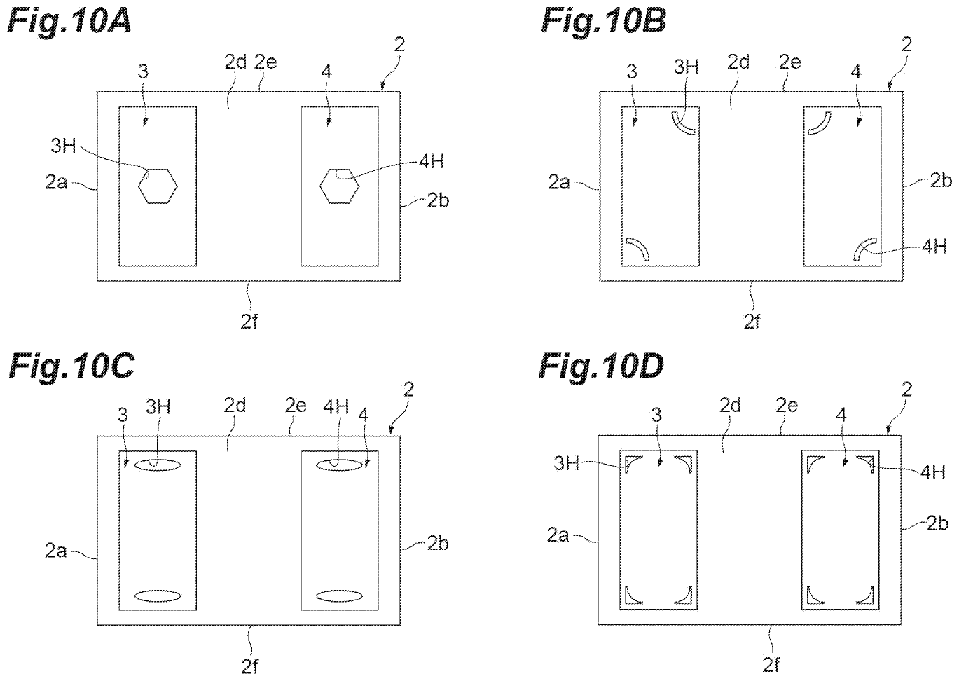

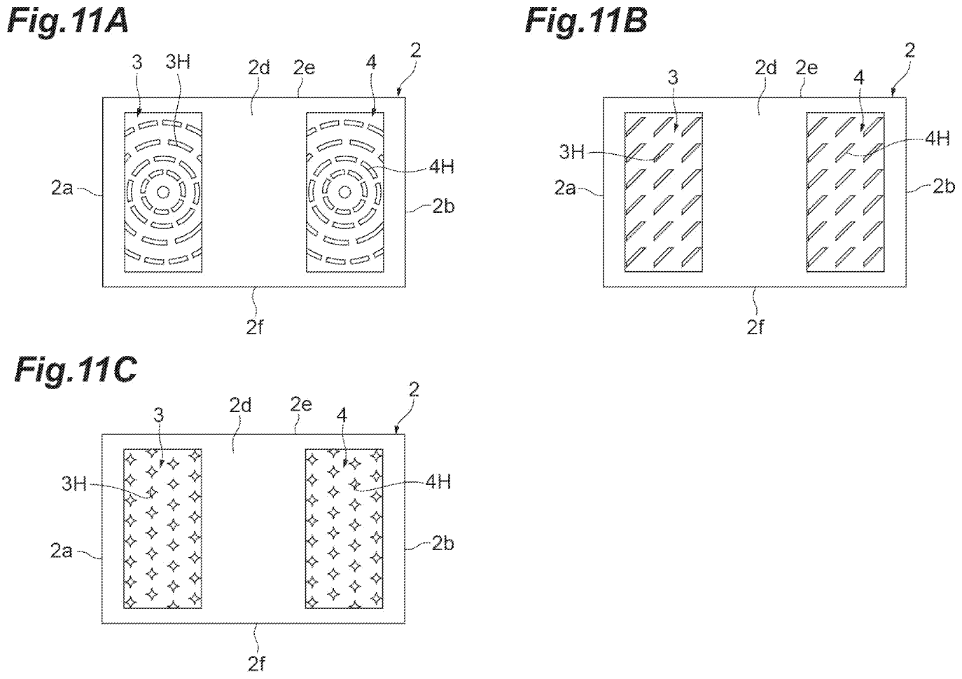

The opening 3H, 4H of the terminal electrode 3, 4 can adopt configurations illustrated in FIGS. 8A, 8B, 8C, 8D, 9A, 9B, 9C, 9D, 10A, 10B, 10C, 10D, 11A, 11B, and 11C. As illustrated in each drawing, the number of openings 3H, 4H may be one or plural. Various shapes can be adopted as the shape of the opening 3H, 4H may have a circular shape, a triangular shape, a polygonal shape, or the like. The plurality of openings 3H, 4H provided in the terminal electrode 3, 4 may have the same shape or different shapes. The position of the opening 3H, 4H may be appropriately set.

What is claimed is:

1. An electronic component comprising:
an element body having a mounting surface; and
an external conductor disposed on the mounting surface,
wherein at least a part of the external conductor is embedded in the element body,
the external conductor has an opening penetrating the external conductor in a direction orthogonal to the mounting surface, and
a part of the element body is disposed in the opening.

2. The electronic component according to claim 1, wherein the element body includes a plurality of metal magnetic particles of a soft magnetic material, and
the metal magnetic particles are disposed in the opening of the external conductor.

3. The electronic component according to claim 1, wherein a conductive member having conductivity is filled in the opening of the external conductor on the element body.

4. The electronic component according to claim 1, wherein the external conductor is a plated conductor.

5. The electronic component according to claim 1, wherein the external conductor has a lattice shape.

6. The electronic component according to claim 1, further comprising a plating layer disposed on the external conductor and disposed to straddle the opening.
